(19) United States
(12) Patent Application Publication
(10) Pub. No.: US 2015/0120315 A1
(43) Pub. Date: Apr. 30, 2015

(54) MULTI-USER, KNOWLEDGE BASED SYSTEM AND METHOD FOR CREATING APPROPRIATE MEDICAL REFERRALS TO SPECIALISTS

(71) Applicants: Jeffrey Dann, Ormond Beach, FL (US); Terrence Regan, Flagler Beach, FL (US)

(72) Inventors: Jeffrey Dann, Ormond Beach, FL (US); Terrence Regan, Flagler Beach, FL (US)

(21) Appl. No.: 14/506,046

(22) Filed: Oct. 3, 2014

Related U.S. Application Data
(60) Provisional application No. 61/961,064, filed on Oct. 3, 2013.

(51) Int. Cl. G06F 19/00

(52) U.S. Cl. CPC G06F 19/324
USPC 705/2

(57) ABSTRACT

Disclosed herein is a multi-user, interactive, medical knowledge based system utilizing disease or problem specific analysis by which healthcare providers, specifically primary care providers, can be notified about the appropriateness and completeness of a patient's medical referral to a specialist.

### FIELD OF THE INVENTION

The present invention relates to the creation and maintenance of a medical knowledge based system in a multi-user healthcare environment and more specifically, to such system for screening appropriate patients based upon supporting clinical data before permitting approval of a referral to a specialist.

### BACKGROUND

Healthcare costs represent a large percentage of the U.S GNP. In today's medical environment, physicians are becoming increasingly time constrained by electronic medical records and e-prescribe systems while experiencing increasing expenses and decreasing reimbursement related to clinical practice. These forces are putting pressure on physicians and, in particular primary care physicians, to maximize patient throughput by decreasing face to face patient time and evaluation of patient complaints. In addition, increased malpractice concerns have made physicians less interested in taking on the responsibility of working up and evaluating specific patient complaints. The end result is a significant increase is patient referrals by primary care providers to specialists, often lacking sufficient medical testing or information for the referral. Specialists are becoming overloaded with inappropriate and incomplete referrals resulting in delayed access to see a specialist and increased healthcare costs for inadequately evaluated referrals.

To date, prior attempts at a solution to this healthcare problem have required the referring primary care healthcare professional to personally contact the specialist or his staff to evaluate the appropriateness of the referral. This informal screening process, also called the “curb-side consult”, is time consuming and inefficient. Recently, San Francisco General Hospital, noting an increased lack of access to specialists because of inappropriate primary care referrals, created a more formal referral system where all specialty referrals were reviewed by the corresponding specialist for appropriateness and completeness before the referral was approved. The hospital system discovered that 40% of the referrals were inappropriate, incomplete, or suitable for primary care management with specialty guidance. Wait times for specialists immediately decreased and cost savings were realized from fewer referrals. The process, however, still required physician communication and was inefficient and relatively expensive. The invention attempts to reduce the inefficiency and cost by creating a menu driven, multi-user computerized medical knowledge based system designed to eliminate the need for live physician or staff intervention.

Current computerized medical decision systems can be broadly categorized as functioning to either: 1) achieve patient monitoring via linking with remote physiologically monitoring devices; 2) provide patients direct access to medical information and advice; and 3) provide physician education by access to medical knowledge databases.

The first category of computerized medical decision systems achieve patient monitoring via remote physiological monitoring devices U.S. Pat. No. 8,346,524 by Turgiss et al. describes a wellness system which monitors the controlled progress of patients under surveillance and includes a server, web-like interface and a local station at the port of use. A unique database is collected for each individual user via an electric device and stored as a management database of the services for monitoring and managing the controlled progress of that member in the program. U.S. Pat. No. 6,594,607 by Lavery describes a medical screening apparatus which communicates the output of medical test devices to a remote site for analysis and U.S. Pat. No. 6,652,456 by Gelfand et al describes a similar device used specifically for remote analysis of Pap Smears for cervical screening.

The second category of computerized interactive medical decision systems facilitate direct patient access to medical information and advice. U.S. Pat. Nos. RE43,548 and RE43,433 by Iliff describe a computerized knowledge based medical diagnostic and treatment system aimed at providing medical advice to the general public over a telephone network. The system is comprised of a computer, an input device connected to the computer to receive information from the patient, an output device connected to the computer to provide information to the patient and a plurality of medical compliant algorithms stored in the computer. The patient enters the system, finds his disease or symptoms and follows a menu driven treatment selection process resulting in the diagnostic medical condition which is then communicated to the patient.

The third category of computerized interactive knowledge based systems provide physician education. U.S. Pat. No. 6,353,817 by Jacobs et al describes a multi-user system to create and modify knowledge bases for use in medical decision making. A general knowledge base is a repository of information. Data is arranged in a hierarchically tree-like structure so the more detail is derived as the user moves further towards the tips of the branches. This database requires frequent updating to correct preexisting problems in the information and add new information which, instead of being done by computer programmers, can be performed instead by the user himself via a graphic interface to the knowledge base. With this system, users can access a wide range of medical information to aid in medical decision-making and modify the knowledge base as needed. U.S. Pat. No. 7,912,278 by Fung et al describes a computerized method of correlating patient information and providing batch classification of any number of related data points to provide a diagnosis.

All the above computerized systems either monitor patients, facilitate direct medical information to patients or provide knowledge base systems to aid healthcare professionals in medical diagnosis and treatment.

### SUMMARY

In accordance with one or more embodiments, the present disclosure describes a computerized multi-user, interactive, knowledge based system utilizing disease or problem specific medical algorithms by which a medical provider, such as a primary care physician, can be notified about the appropriateness and completeness of a patient's medical referral to a specialist. Unlike the current systems described above, the present invention serves primarily as a screening tool to prevent inappropriate or inadequately evaluated specialty referrals. The user connects with the Program, preferably through the internet or web based interface, and selects the disease or problem that the patient is experiencing. The Program then asks the user a short series of questions arranged in a logic based sequence or algorithm and depending upon the answers determines if the correct pre-consultation evaluation, testing and management has occurred and if the referral is appropriate based upon these results. The algorithm evaluates the user's responses after each question and determines if the patient referral should be Approved, Denied or Not Approved pending additional testing and/or treatment. Unlike verbal “curb-side consults”, it is efficient, inexpensive, reproducible and standardized according to evidence based medicine, peer review literature and best practice guidelines.

According to another aspect, disclosed is a multi-user, interactive, knowledge based system that can also provide a method for evaluating and screening the appropriateness and completeness of a patient's referral to a specialist by applying a disease or problem specific medical algorithm which evaluates the user's responses to a short series of questions arranged in a logic based sequence and depending upon the answers determines if the correct pre-consultation evaluation, testing and management has occurred and if the referral is appropriate based upon these results. The algorithm evaluates the user's responses after each question and determines if the patient referral should be Approved, Denied or Not Approved pending additional testing and/or treatment.

According to another aspect, provided is a multi-user, interactive, knowledge based system that can educate users as to the appropriate pre-consultation testing, evaluation, and management necessary before a specialist referral is appropriate. In accordance with another embodiment, the system provides published information and answers to user queries with links to important peer review literature and best practice guidelines.

According to another aspect, a multi-user, interactive, knowledge based system is disclosed that can also provide a method for easy user access to educational information concerning specific problems and diseases by describing appropriate pre-consultation testing, evaluation and management and guiding users to medical links, peer review literature and best practice guidelines.

### BRIEF DESCRIPTION OF THE DRAWINGS

These, and further features of the invention, may be better understood with reference to the accompanying specifications and drawings depicting the preferred embodiment in which:

FIG. 1: Depicts a block diagram of a the multi-user system.

FIG. 2A: Depicts a flow chart of a knowledge based program embodiment.

FIG. 2B: Depicts an alternative flow chart of a knowledge based program embodiment.

FIG. 3: Depicts a flow chart of one embodiment of a Problem/Disease Specific algorithm (Microscopic Hematuria) describing a multi-node hierarchy and outcomes for the algorithm.

FIG. 4: Depicts a flow chart of another embodiment of a Problem/Disease Specific algorithm (Elevated PSA) describing the multi-node hierachy and outcomes for the algorithm.

FIG. 5 shows a diagram of a system embodiment.

### DETAILED DESCRIPTION

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

It is important to an understanding of the present invention to note that all technical and scientific terms used herein, unless defined herein, are intended to have the same meaning as commonly understood by one of ordinary skill in the art. The techniques employed herein are also those that are known to one of ordinary skill in the art, unless stated otherwise. For purposes of more clearly facilitating an understanding the invention as disclosed and claimed herein, the following definitions are provided. It should be borne in mind that all patents, patent applications, patent publications, technical publications, scientific publications, and other references referenced herein are hereby incorporated by reference in this application in order to more fully describe the state of the art to which the present invention pertains.

In certain embodiments, the current invention is a web based, multi-user system that offers users knowledge based specialty and problem/disease specific algorithms for screening whether or not a patient is appropriate for a specialty referral and/or whether additional clinical testing or information needs to be obtained before the referral can be adequately evaluated. The typical user is a primary care physician or healthcare professional who is considering referring a patient to a specialist. The user accesses the system, selects the specialty of interest, then selects the disease or clinical problem for which a referral is being considered. Once in the disease or problem specific subprogram, the user is guided through multiple clinical question nodes according to the preset algorithms. Answers to one or more of these question nodes will ultimately result in three outcomes for the referral: 1) Denied if the clinical condition or tests results do not demonstrate medical appropriateness for the referral; 2) Approved if the clinical condition and supporting tests demonstrate medical appropriateness; or 3) No Referral until additional clinical tests or information is collected by the user in order for the subprogram to adequately judge the referrals appropriateness.

As will be appreciated by one of skill in the art, embodiments of the present invention may be embodied as a device or system comprising a processing module, and/or computer program product comprising at least one program code module. Accordingly, the present invention may take the form of an entirely hardware embodiment or an embodiment combining software and hardware aspects. Furthermore, the present invention may include a computer program product on a computer-usable storage medium having computer-usable program code means embodied in the medium. Any suitable computer readable medium may be utilized including hard disks, CD-ROMs, DVDs, optical storage devices, or magnetic storage devices.

The term “processing module” may include a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The processing module may have operationally coupled thereto, or integrated therewith, a memory component. The memory component may be a single memory component or a plurality of memory components. Such a memory component may be a read-only memory (ROM), random access memory (RAM), volatile memory, non-volatile memory, static memory, dynamic memory, flash memory, an erasable programmable read-only memory (EPROM or Flash memory), an optical fiber, and a portable compact disc read-only memory (CD-ROM), a CD ROM, a DVD (digital video disk), and/or any other electronic device that stores digital information.

A “computer” or “computer unit”, as used herein, is intended to include a device that comprises at least one processing module.

The computer-usable or computer-readable medium may be or include, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM), a CD ROM, a DVD (digital video disk), or other electronic storage medium.

Computer program code for carrying out operations of certain embodiments of the present invention may be written in an object oriented and/or conventional procedural programming languages including, but not limited to, Java, Smalltalk, Perl, Python, Ruby, Lisp, PHP, “C”, FORTRAN, or C++. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Certain embodiments of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer-readable program code modules. These program code modules may be provided to a processing module of a general purpose computer, special purpose computer, embedded processor or other programmable data processing apparatus to produce a machine, such that the program code modules, which execute via the processing module of the computer or other programmable data processing apparatus, create means for implementing the functions specified in the flowchart and/or block diagram block or blocks.

These computer program code modules may also be stored in a computer-readable memory that can direct a computer or other programmable data processing apparatus to function in a particular manner, such that the program code modules stored in the computer-readable memory produce an article of manufacture.

The computer program code modules may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

The term “analyzer device” as used herein refers to a device for determining the presence and/or concentration of an analyte in a biological sample. Examples of analyzer devices useful in accord with certain embodiments disclosed herein include, but are not limited to, devices such as clinical chemistry analyzer machines, gas analyzer machine, hematology analyzer machines, immunoassay analyzer machines, albumin analyzer machine, glucose reader and the like. Analyzer device also includes gel electrophoresis equipment, ELISA equipment including well-plates and/or machine for reading colorimetric/fluorometric information. Analyzer device could pertain to a physical substrate having chemical reagents disposed thereon that produces a signal upon contact with an analyte with the substrate. Examples of physical substrates include but are not limited to strip or dipstick with reagent pad(s).

The term “analyte” as used herein refers to a molecule, chemical compound or structure that is present in a biological sample. Examples of analytes include but are not limited to HbCO, HbMet, Hbt, SpaO2, HbO2, Hb, blood glucose, water, therapeutic drugs (aspirin, dapson, nitrates, or the like) or abusive drugs (methamphetamine, alcohol, or the like), concentrations of carbon dioxide (“CO2”), oxygen (“O”), ph levels, bilirubin, perfusion quality, signal quality, albumin, cyanmethemoglobin, and sulfhemoglobin (“HbSulf”), blood urea nitrogen (BUN), nitric oxide (NO), uric acid, bacteria, virus, antibodies, antigen, sodium, potassium, chloride bicarbonate, magnesium, creatinine, calcium, LDL cholesterol, HDL cholesterol, triglycerides, bilirubin, enzymes (such as transaminase, gamma-glutamyl transferase, alkaline phosphatase), cells (including but not limited to red blood cells and white blood cells), ketone, cortisol, or amino acid.

The term “physiological parameter” as used herein refers to patient medical information that does not necessarily involve analyzing an analyte in a biological sample. Examples of physiological parameters include but are not limited to ECG, EKG, blood pressure, temperature, SpO2, pulse rate, respiratory rate, inspiratory time, expiratory time, inspiratory to expiratory ratio, inspiratory flow, expiratory flow, tidal volume, minute volume, apnea duration, breath sounds—including rales, rhonchi, or stridor, changes in breath sounds, heart rate, heart sounds—including S1, S2, S3, S4, or murmurs, or changes in heart sounds, eye dilation response, nerve response, muscle response, or the like.

The term “medical image” relates to an image or medical information conveyed by an image as produced by convention medical imaging techniques. Such techniques include but are not limited to, x-ray, MRI, ultrasound, photoacoustics, echocardiography, function near-infrared spectroscopy, thermography, elastography, tomography, and the like.

The term “physiological parameter device” as used herein pertains to a device configured to obtain information from a patient regarding a physiological parameter.

The term “input component” as used herein refers to a component that delivers information keyboard, tracking device (such as a computer mouse), scanner, joystick or camera. Input component also pertains to circuitry configured to provide wired or wireless connectivity with another device to convey information. A nonlimiting example for illustration purposes only pertains to a database device having an input component that receives information from an analyzer device about an analyte.

The term biological sample as used herein refers to blood, plasma, urine, saliva, vaginal fluid, fecal sample, tears, perspiration, wound exudate, mucus, tissue sample, cell sample, or semen.

The term “patient” or “subject” as used herein refers to a human or non-human animal.

It should be noted that the terms “may,” “might,” “can,” and “could” are used to indicate alternatives and optional features and only should be construed as a limitation if specifically included in the claims. Claims not including a specific limitation should not be construed to include that limitation.

It should be noted that, unless otherwise specified, the term “or” is used in its nonexclusive form (e.g. “A or B” includes A, B, A and B, or any combination thereof, but it would not have to include all of these possibilities). It should be noted that, unless otherwise specified, “and/or” is used similarly (e.g. “A and/or B” includes A, B, A and B, or any combination thereof, but it would not have to include all of these possibilities). It should be noted that, unless otherwise specified, the term “includes” means “comprises” (e.g. a device that includes or comprises A and B contains A and B but optionally may contain C or additional components other than A and B). It should be noted that, unless otherwise specified, the singular forms “a,” “an,” and “the” refer to one or more than one, unless the context clearly dictates otherwise.

Currently, many healthcare institutions are transitioning or have transitioned from paper documentation to electronic medical record systems, in which patients' longitudinal medical information is stored in a data repository in electronic form. Besides the significant physical space savings afforded by the replacement of paper record-keeping with electronic storage methods, the use of electronic medical records also provides beneficial time savings and other opportunities to clinicians and other healthcare personnel. For example, when updating a patient's electronic medical record to reflect a current patient encounter, a clinician need only document the new information obtained from the encounter, and need not spend time entering unchanged information such as the patient's age, gender, medical history, etc. Electronic medical records can also be shared, accessed and updated by multiple different personnel from local and remote locations through suitable user interfaces and network connections, eliminating the need to retrieve and deliver paper files from a crowded file room.

Typically, an Electronic Medical Record (EMR) is maintained as a structured data representation, such as a database with structured fields. Each piece of information stored in such an EMR is typically represented as a discrete (e.g., separate) data item occupying a field of the EMR database. According to one embodiment, a system embodiment is disclosed that interacts with an EMR database whereby information responsive to one or more of a series of questions is automatically inputted into fields pertaining to such information.

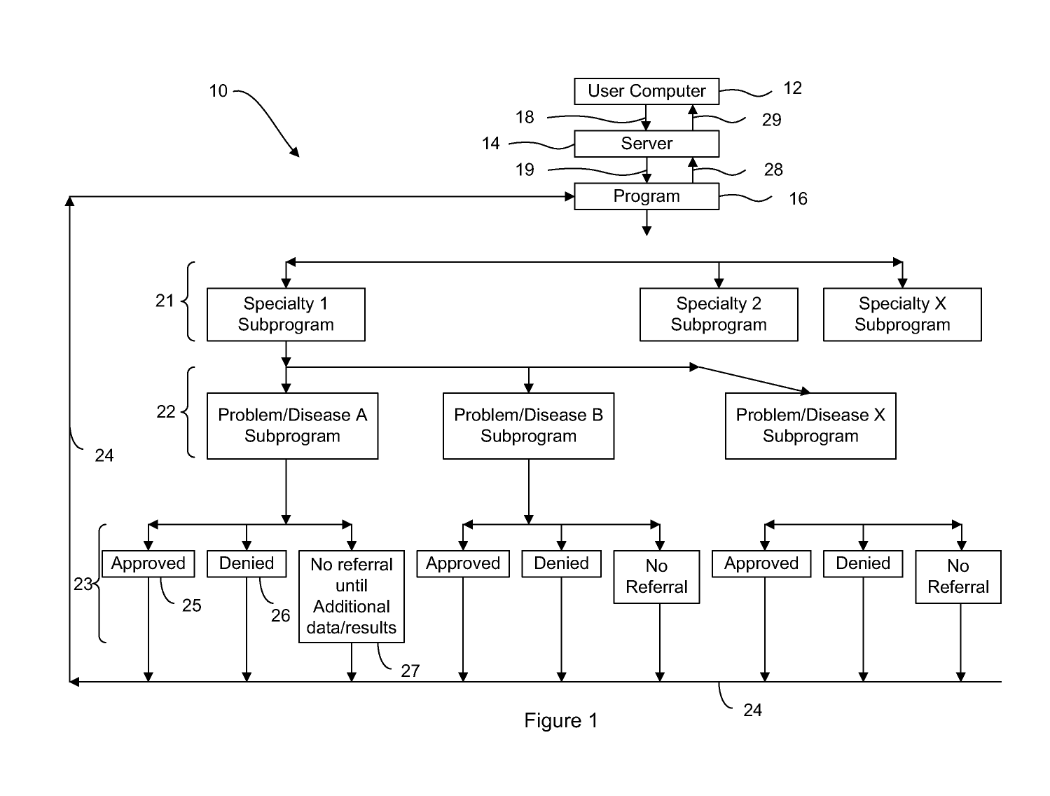

FIG. 1 depicts an overall block diagram of the multi-user system (10). In the preferred embodiment, the system (10) is web based although in an alternative embodiment it can also consist of a non web-based software program. The user would typically be a primary care healthcare professional (e.g. primary care physician, nurse practitioner, physician assistant, etc) who is referring a patient to a specialist for a specialty related problem. There are cases, however, when a specialist may use the system (10) to refer a patient to another specialist. In a typical scenario, the user would access the system (10) by logging onto a personal computer (12). The user would then gain access to the server (14) through an internet portal (18) displayed on the patient's Health Insurance website or directly from the internet. The server (14) then connects (19) to the program (16). The user selects the appropriate specialty (21) followed by the specialty specific problem/disease (22) and proceeds along the problem/disease specific algorithm chosen until one of three outcome decisions (23) is reached for the referral: Approved (25), Denied (26) or No Referral until additional data results are obtained (27). The outcome decision (23) is then transmitted (24) back to the Program (16) and from there is transmitted (28) to the server (14) and finally sent via the internet portal (29) to the users computer (12). The end result is that the user learns whether his referral is approved, denied, or incomplete.

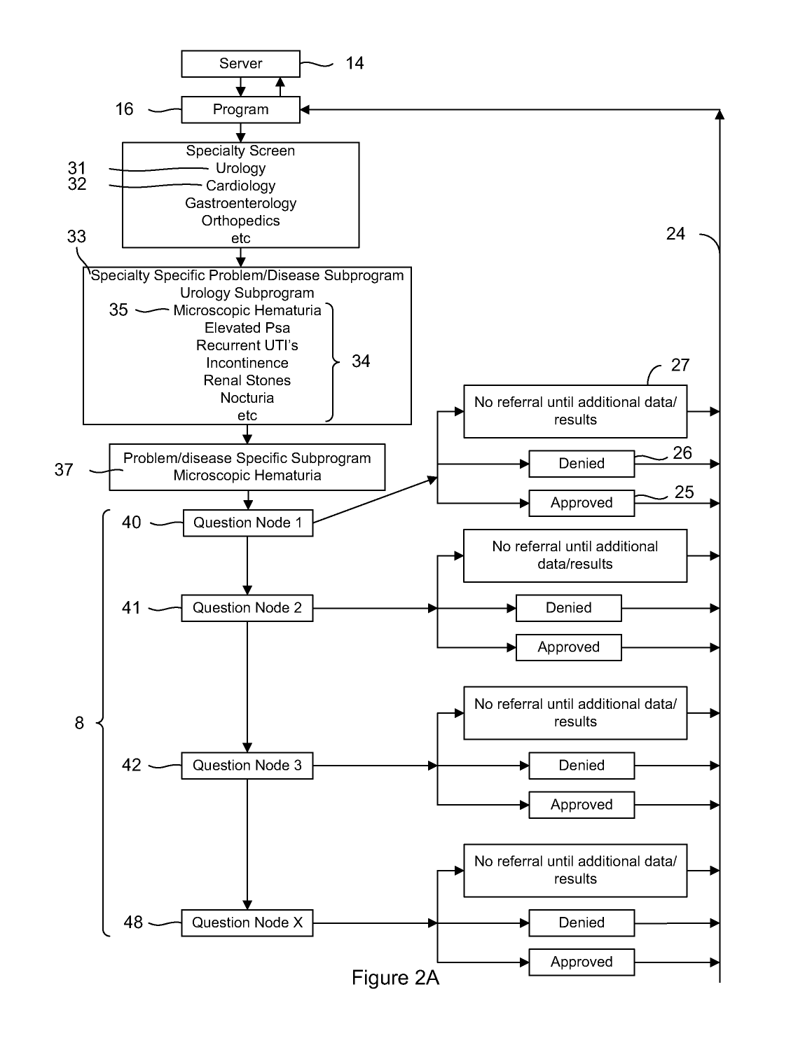

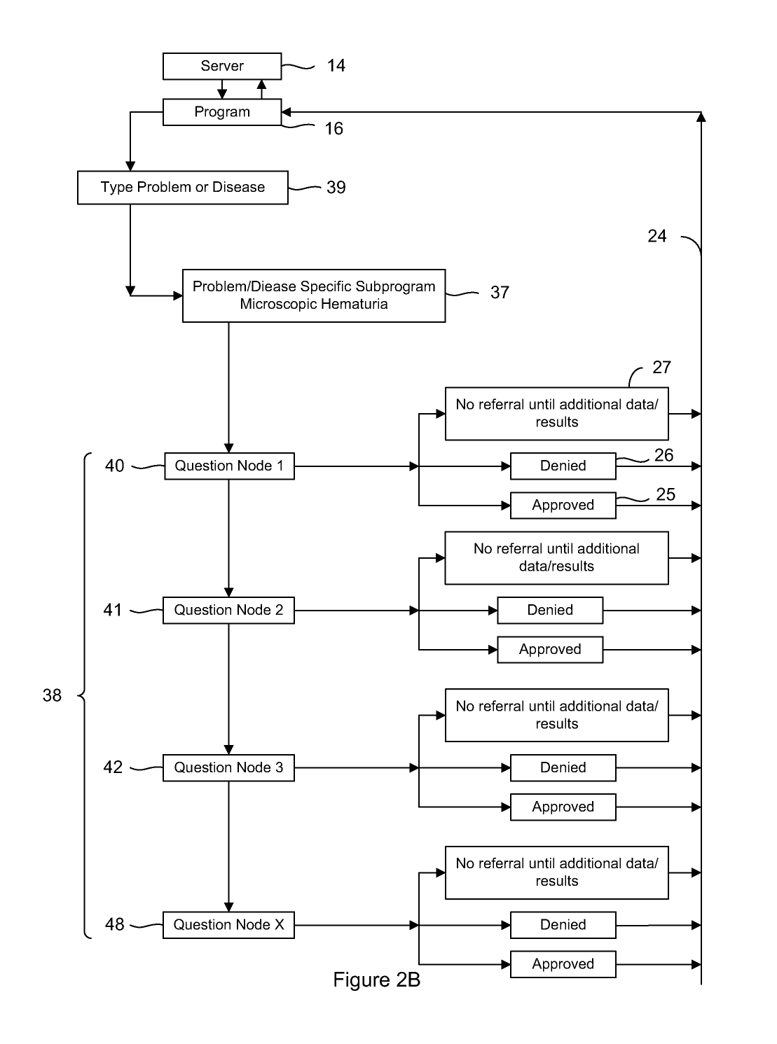

FIG. 2A depicts a flow chart of the knowledge based program (16). In this Figure, the user desires to make a referral to a specialist (in this case a urologist) for the specialty specific problem of microscopic hematuria (microscopic blood in the urine). In the preferred embodiment, the user has logged into the program (16) in the fashion described above. The user is initially guided to the Specialty Screen (32) which identifies a plurality of specialty areas. The user selects the specialty relevant to the problem/disease, in this example selecting Urology (31). After selecting the specialty, the program defaults to a Specialty Specific Problem/Disease Subprogram (33), which lists a plurality of problems/diseases specific for the specialty (34). The user then selects the specific problem or disease from this screen. In this example, the user selects microscopic hematuria (35). The program then defaults to the Problem/Disease Specific Subprogram requested by the user, in this case the Microscopic Hematuria Subprogram (37). The user would then encounter a plurality of Question Nodes (38) arranged in a knowledge based algorithm which would result in the referral being either Denied (26), Approved (25), No Referral until additional data/results is collected (27), or the next Question Node in the algorithm. Each new Question Node would require additional clinical data and build upon the Question Node preceding it. In the current example, Question Node 1 (40) would lead the user to Question Node 2 (41) if the outcome of Question Node 1 (40) was neither Denied (26), Approved (25) or No Referral until additional data/results were obtained (27). Question Node 2 (41) would in turn lead to Question Node 3 (42) if neither Denied (26), Approved (25), or No Referral until additional data/results were obtained (27). The algorithm would proceed down the knowledge based tree until the final Question Node X (48) was reached at which point the subprogram would end with one of the three outcomes: Denied (26), Approved (25) or No Referral until additional data/results are obtained (27). The outcome decision is then transmitted (24) to the Program (16) and then to the user via the server (14). The user would then be notified if the patient was denied for referral, approved for referral or needs additional testing or information before reconsideration of the appropriateness of the referral by either fax, email or printed version generated by the Program (16). In the preferred embodiment, all Question Nodes (38) would be contained on a single screen with the user answering each question sequentially according to the algorithm pathway. In another embodiment, each Question Node (38) can have a dedicated screen with each screen appearing sequentially along the algorithm pathway.

FIG. 2B depicts a flow chart of another embodiment of the knowledge based program (16). In this embodiment, the user can avoid the Specialty Screen (32) and Specialty Specific Problem/Disease Screen (33) described in FIG. 2A by directly typing in the problem or disease on a Problem or Disease Screen (39) immediately after entrance into the Program (16). This would then default directly to the Problem/Disease Specific Subprogram (37) requested. In the above example, the user would type in Microscopic Hematuria on the Problem or Disease Screen (39) and default to the Microscopic Hematuria Subprogram (37), thereby avoiding the Specialty Screen (32) and Specialty Specific Problem/Disease Screen (33).

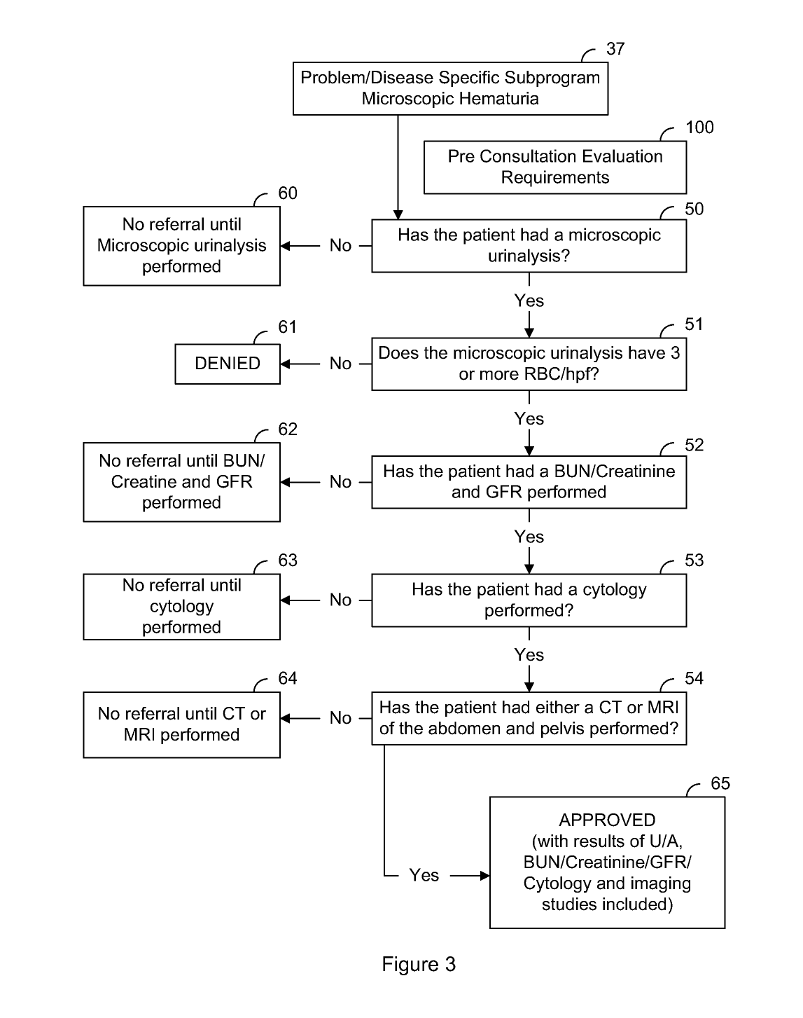

FIG. 3 depicts a flow chart of one embodiment of a Problem/Disease Specific Subprogram, Microscopic Hematuria (37), describing the multi-node hierarchy and outcomes for this algorithm. Question Node 1 (50) asks the user “Has the patient has a microscopic urinalysis?” If the answer by the user is No, the user is directed to a screen (60) which notifies him that the referral is not approved until a microscopic urinalysis is performed. If the answer by the user is Yes, the user then proceeds to Question Node 2 (51) which ask “Does the microscopic urinalysis have 3 or more RBC per high power field (hpf)?”. If the answer by the user is No, the user is directed to a screen (61) which notifies him that the referral has been Denied since the patient does not meet the criteria for microscopic hematuria. If the answer by the user is Yes, the user then proceeds to Question 3 Node (52) which asks “Has the patient had a BUN, Creatinine and GFR performed?”. If the answer by the user is No, the user is directed to a screen (62) which notifies him that the referral is not approved until these tests are performed. If the answer by the user is Yes, the user then proceeds to Question Node 4 (53) which asks “Has the patient had a cytology performed?”. If the answer by the user is No, the user is directed to a screen (63) which notifies him that the referral is not approved until the test is performed. If the answer by the user is Yes, the user then proceeds to Question Node 5 (54) which asks “Has the patient had either a CT Scan or MRI of the abdomen/pelvis performed?”. If the answer by the user is No, the user is directed to a screen (64) which notifies him that the referral is not approved until a CT Scan or MRI is performed. If the answer is Yes, the user is directed to a screen (65) that notifies him that the referral is Approved and to forward all the test results to the specialist. In the above example, the referral is Denied only if the patient does not meet the criteria for microscopic hematuria and Approved only if the appropriate pre-consultation testing has been performed. The above algorithm for Microscopic Hematuria is only one embodiment of that problem/disease. Other embodiments may include additional or modified Question Nodes and/or subprograms. In the above embodiment, the user is notified about the referral outcome at each Question Node by defaulting to a separate screen. In the preferred embodiment, the user would receive this information on a single screen along with the responses to each Question Node.

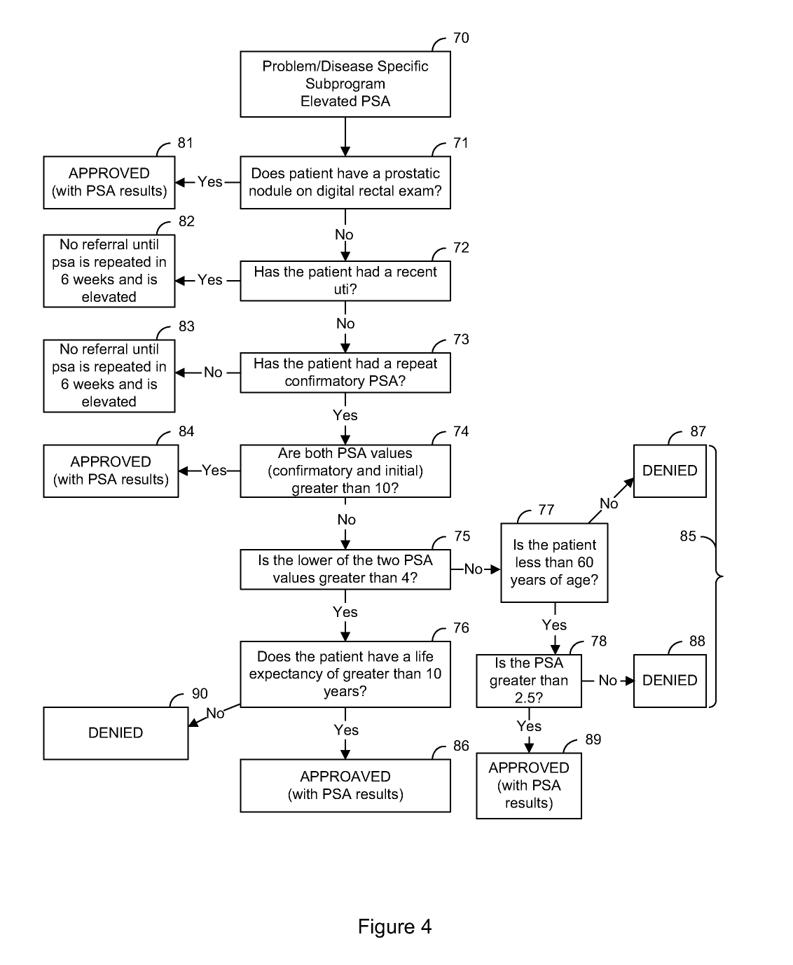

FIG. 4 depicts a flow chart of another embodiment of a Problem/Disease Specific Subprogram, Elevated PSA (70), describing the multi-node hierarchy and outcomes for this algorithm. Question Node 1 (71) ask the user “Does the patient have a prostate nodule on digital rectal exam?”. If the answer by the user is Yes, the user is directed to a screen (81) which notifies him that the referral is Approved and to forward the PSA test results to the specialist. If the answer by the user is No, the user then proceeds to Question Node 2 (72) which asks “Has the patient had a recent UTI?”. If the answer by the user is Yes, the user is directed to a screen (82) which notifies him that the referral is not approved until a repeat PSA in 6 weeks is elevated. If the answer by user is No, the user then proceeds to Question Node 3 (73) which asks “Has the patient had a repeat confirmatory PSA ?”. If the user answers No, the user is directed to a screen (83) which notifies him that the referral is not approved until a repeat confirmatory PSA is performed within 6 weeks and is elevated. If the user answers Yes, the user proceeds to Question Node 4 (74) which asks “Are both PSA values (confirmatory and initial) greater than 10 ?”. If the user answers Yes, the user is directed to screen (84) which notifies him that that the referral is Approved and to forward the PSA testing results to the specialist. If the user answers No, the user proceeds to Question Node 5 (75) which asks “Is the lower of the two PSA values greater than 4?”. If the users answer is No, the user is directed to a subprogram (85) which is specific to patients under the age of 60. The user proceeds along the subprograms algorithm to further Question Nodes (77, 78) and receives either an answer of Denied (87, 88) or Approved (89) depending upon the user responses. If the user answers Yes to Question Node 5 (75), the user proceeds to Question Node 6 (76) which asks “Does the patient have a life expectancy of greater than 10 years ?”. If the user answers Yes, the user is directed a screen (86) which notifies him that the referral is Approved and to forward the PSA test results to the specialist. If the user answers No, the user is directed to a screen (90) that notifies him that the referral is Denied. In the above example, the referral is Denied or Approved based upon the patient's PSA values, digital rectal examination and life expectancy. The above algorithm for Elevated PSA is only one embodiment of that problem/disease. Other embodiment may include additional or modified Question Nodes and/or subprograms. As previously stated, in the preferred embodiment the user is notified about the referral outcome on a single screen along with the responses to each Question Node.

For each Specialty Specific Problem or Disease, the number of Question Nodes can vary depending upon the complexity of the medical issue; however, in the preferred embodiment should be between three and ten so as not to be overwhelming to the user. The outcome of each Question Node is either: 1) Denied; 2) Approved; 3) No Referral until additional information or studies are performed; or 4) Default to the next Question Node. The exception to the above is the final Question Node in the algorithm which cannot direct the user to additional questions. In the preferred embodiment, Question Nodes and outcomes are standardized for all users; however, in another embodiment both the Question Nodes and outcomes can be customized for a specific specialty practice pattern or preferences. Each Specialty Specific Problem/Disease algorithm may vary in length and complexity depending upon the medical issue and are based upon peer review literature, specialty guidelines, best practices, and expert opinion. The Specialty Specific Problem/Disease algorithms are not static and can be modified over time as medical knowledge and decision making changes. For each Specialty, the number of Specialty Specific Problem/Diseases can vary, however; the Program is not meant to capture every clinical problem, but rather the most common referrals to that specialty. In a typical embodiment, the number of Specialty Specific Problem/Diseases should be between ten to fifteen of the most commonly referred problems. The Program is scalable so as to add as many Specialties and additional Specialty Specific Problem/Diseases within that specialty as needed.

Although the Program serves primarily as a screening tool to avoid inappropriate and/or inadequately evaluated referrals it may also serve as an educational tool to users by teaching them the appropriate evaluation of the most common medical issues. Referring to FIG. 3, for example, upon entrance into a Problem/Disease Specific Subprogram the user can press the Pre-consultation Evaluation Requirements button or icon (100) which would display the required evaluation, testing and treatment management necessary before a referral can be adequately evaluated. Further educational information can be directly accessed by the user at each step in a Problem/Disease Specific Subprogram to learn why each element in the Pre-consultation Evaluation Requirement (100) is important. In another embodiment, the Program can be expanded to allow the user to directly access peer review literature and best practice guidelines for any particular Specialty Specific Problem/Disease algorithm or Question Node. Such information can be accessed via medical literature posted on the algorithm itself or referral to appropriate medical websites.

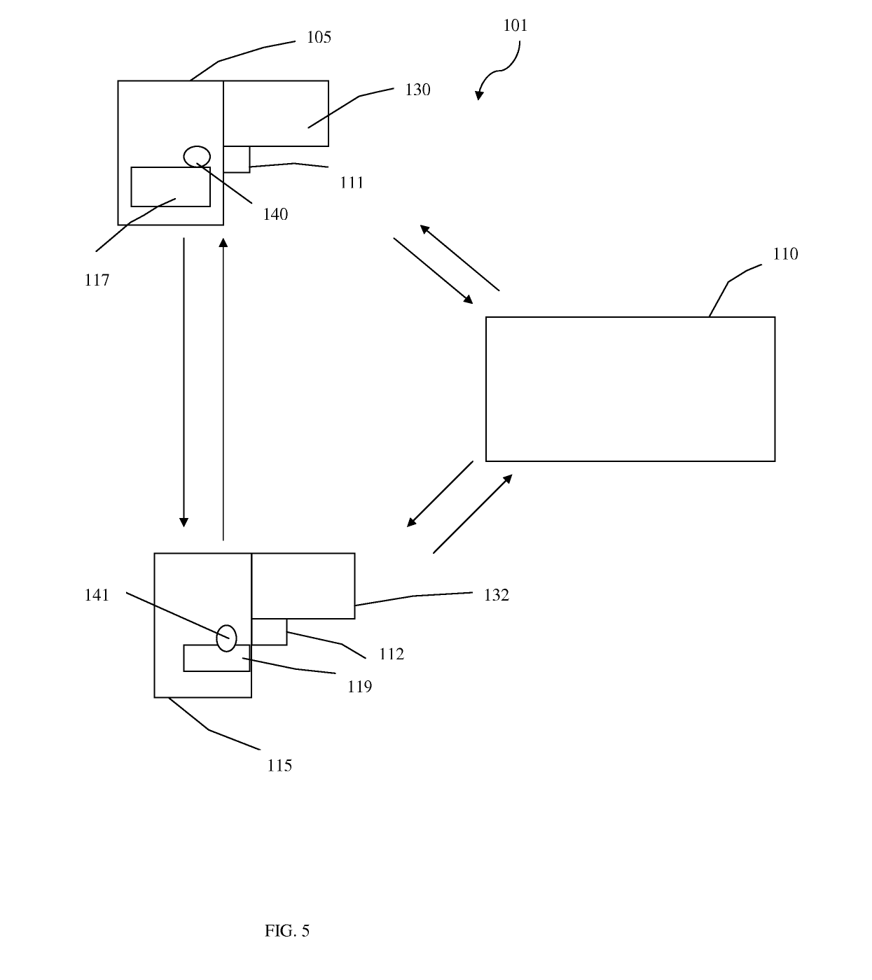

FIG. 5 shows a system embodiment 101 that includes a database device 105 that may also function as a central computer unit of a network that is communicatingly connected (shown as arrows) to a medical provider computer unit 115 that is positioned remotely (typically in a medical office or other medical service facility). The database device 105 includes a display 130 (optional if serving as a network central computer unit), and a processing module 140 that is associated with a memory component 117. Also, the database device 105 includes an input component 111 (optional). The provider computer unit 115 includes a display 132, a processing module 141 that is associated with a memory component 119. The provider computer unit 115 also includes an input component 112.

Regarding the database device 105, one or more program code modules that execute certain functions are stored on the memory component 117. These computer program code modules may include the following: (a) a first program code module for causing a field to be displayed on said display for selecting of a medical specialty of interest; (b) a second program code module for causing a field to be displayed on said display for selecting a specific disease or medical condition related to the selected medical specialty; (c) a third program code module for (i) causing at least one analyte field to be displayed on said display for inputting information concerning said analyte of interest or (ii) causing a first bank of questions to be displayed on the display, wherein at least one question is displayed with a field for selecting a response from a list of two or more responses, or both (i) and (ii); (d) a fourth program code module for causing a first output to be displayed on said display generated based on responses to said first question node, wherein said first output indicates that a referral to the medical specialty is approved, denied, requires additional data/results or initiates a second question node; and optionally: (e) a fifth program code module for causing a second question node to be displayed on the display, wherein at least one question is displayed with a field for selecting a response from a group of two or more responses; and (f) a sixth program code module for causing a second output to be displayed on said display generated based on response to said second question node, wherein said second output indicates that a referral to the medical specialty is approved, denied, or requires additional data/results. The database device may optionally further comprise a computer program code module that records and tracks an amount of approved, not recommended, and deferred for further testing/management outcomes for said first provider.

When the database device 105 is the computer upon which the medical provider directly interacts (e.g. situated in the medical office or facility), information is inputted directly onto the database device via input component 111. When the database device 105 is part of a network with the provider computer unit 115, it is contemplated that the provider computer unit 115 will be situated in the medical office or facility and the database device 105 will be accessed via the network. In this network situation, information is inputted through the provider computer unit 115 via the input component 112. In the network environment, part of the relevant program code modules may be stored on memory component 117 and others stored locally on memory component 119.

Further, the database device 105 and/or provider computer unit 115 may be communicatingly connected with a peripheral medical device 110. The peripheral medical device is typically a physiological parameter device or analyzer device. Information obtained by the peripheral medical device 110 can be automatically inputted into the database device 105 or provider computer unit 115 depending on the arrangement. Typically, the information obtained by the peripheral medical device is automatically populated in a field related to the information or is responsive to one or more questions in the question node.

Having described preferred embodiments of the invention, it will now become apparent to one skilled in the art that other embodiments incorporating their concepts may be used. These embodiments should not be limited disclosed embodiments, but should only be limited by the spirit and scope of the claims.

1. A interactive system for reducing patient referral errors, the system comprising
a central computer unit communicatingly connected to a first provider computer unit and a display associated therewith, central computer unit comprising a processing module and a memory component onto which a plurality of program code modules are stored; the plurality of program code modules comprising:
a first program code module for causing a field to be displayed on said display for selecting of a medical specialty of interest by a first medical provider;
a second program code module for causing a field to be displayed on said display for selecting a specific disease or medical condition related to the selected medical specialty;
a third program code module for causing a first question node to be displayed on the display, wherein the first question node is displayed with a field for inputting a first response, wherein said first response is a selection from a group of two or more responses or a medical information input;
a fourth program code module for causing a first output to be displayed on said display generated based on said first response, wherein said first output indicates that a referral to the medical specialty is approved, denied, requires additional data/results or initiates a second question node; and optionally:
a fifth program code module for causing a second question node to be displayed on the display, wherein the second question node is displayed with a field for inputting a second response, wherein said second response is a selection from a group of two or more responses or a medical information input; and
a sixth program code module for causing a second output to be displayed on said display generated based on said second response, wherein said second output indicates that a referral to the medical specialty is approved, denied, or requires additional data/results;
wherein said first through sixth program code modules are executed entirely or partly on said central computer unit or entirely or partly on said first provider computer unit.

2. The system of claim 1, wherein said first through sixth program code modules are executed partly on said central computer unit and partly on said first provider computer unit.

3. The system of claim 1, further comprising a seventh program code module that records and tracks an amount of approved, not recommended, and deferred for further testing/management outcomes for said first provider.

4. The system of claim 1, wherein said first provider computer unit interacts with an electronic medical record system such that patient information responsive to one or more of said first or second question nodes is automatically inputted.

5. The system of claim 1, wherein said first provider computer unit is communicatingly connected with an analyzer device or a physiological parameter device, or both.

6. The system of claim 5, wherein analyte information or physiological parameter information obtained from the analyzer device or physiological parameter device, respectively, is delivered to the first provider computer unit.

7. The system of claim 6, wherein said analyte information or physiological parameter information is responsive to one or more questions of said first and second series of questions and is automatically inputted.

8. The system of claim 1, further comprising at least one more additional program code module for causing at least one more additional question node to be displayed on the display, wherein the at least one more question node is displayed with a field for inputting a response to the at least one more question node comprising a selection from a group of two or more responses or a medical information input.

9. The system of claim 8, further comprising at least one more additional program code module for causing a subsequent output to be displayed on said display after the at least one more response, wherein said subsequent output indicates that a referral to the medical specialty is approved, denied, or requires additional data/results.

10-19. (canceled)

20. A database device, wherein said database device comprises a computer unit comprising a display, a processing module, an input component and a memory component associated therewith, the memory component comprising a plurality of program code modules stored thereon; the plurality of program code modules comprising:
(a) a first program code module for causing a field to be displayed on said display for selecting of a medical specialty of interest;
(b) a second program code module for causing a field to be displayed on said display for selecting a specific disease or medical condition related to the selected medical specialty;
(c) a third program code module for causing a first question node to be displayed on the display, wherein the first question node is displayed with a field for inputting a first response, wherein said first response is a selection from a group of two or more responses or a medical information input;
(d) a fourth program code module for causing a first output to be displayed on said display generated based on said first response, wherein said first output indicates that a referral to the medical specialty is approved, denied, requires additional data/results or initiates a second question node; and optionally:
(e) one or more additional question node program code modules for causing a one or more additional question nodes to be displayed on the display, wherein the one or more additional question nodes are each displayed with a field for inputting one or more additional responses depending on an amount of the one or more additional program code modules; and
(f) one or more additional output program codes modules, depending on an amount of one or more additional program codes from element (e) for causing one or more additional outputs to be displayed on said display, wherein subsequent to each of one or more additional responses one or more additional outputs each, wherein said second output indicate that a referral to the medical specialty is approved, denied, or requires additional data/results.

21. A method for reducing patient referral errors, the method comprising
first selecting from a plurality medical specialties a medical specialty of interest, wherein first selecting comprises actuating an input component connected to a computer unit having a display that is displaying said plurality of specialties;
second selecting from a plurality of specific diseases or medical conditions related to medical specialty of interest a disease or medical condition of interest; wherein selecting comprises actuating the input component connected to the computer unit that while the display is displaying said plurality of specific diseases or medical conditions;
first inputting a first response to a first question node related to the disease or medical condition of interest; wherein first inputting comprises actuating the input component connected to the computer while the display is displaying a field for entering the first response;
receiving a first output on said display, said first output comprising an indication that a referral to the medical specialty is approved, denied, requires additional data/results or initiates a second question node that is displayed on the display;
if a second question node is initiated; second inputting a second response to the second question node; said second inputting comprises actuating the input component connected to the computer while the display is displaying a field for entering the second response; and
if second response is inputted, receiving a second output, said second output comprising an indication that a referral to the medical specialty is approved, denied, requires additional data/results or initiates a second question node that is displayed on the display.

22. The method of claim 21, further comprising inputting at least one additional response to at least one more question node that is displayed with a field for inputting a response to the at least one more question node by actuating the input component connected to the computer while the display is displaying a field for entering the at least one more additional response.

23. The method of claim 22, further comprising receiving on the display at least one more additional output subsequent to inputting the at least one more additional response, wherein said subsequent output indicates that a referral to the medical specialty is approved, denied, or requires additional data/results.

24. The method of claim 21, further comprising acquiring a physiological parameter or medical image of interest from said patient using a physiological parameter device; and inputting said physiological parameter or medical image of interest into said computer.
